(19) United States
(12) Patent Application Publication
(10) Pub. No.: US 2025/0091074 A1
(43) Pub. Date: Mar. 20, 2025

(54) WINTERIZATION ASSEMBLY FOR WATER PLAY AREA INSTALLATIONS

(71) Applicant: Landscape Structures Inc., Delano, MN (US)

(72) Inventors: Greg A. STOKS, Rockford, MN (US); Philip D. BURANDT, Waconia, MN (US)

(21) Appl. No.: 18/889,966

(22) Filed: Sep. 19, 2024

Related U.S. Application Data
(60) Provisional application No. 63/583,984, filed on Sep. 20, 2023.

(51) Int. Cl. B05B 12/00; B05B 12/02; B05B 17/08

(52) U.S. Cl. CPC B05B 12/002; B05B 12/02; B05B 17/08

(57) ABSTRACT

A water play area installation that includes an underground reservoir tank installed at least partially underground. The water play area installation also includes a water flow regulation hub integrated into the water reservoir tank.

### CROSS-REFERENCE TO RELATED APPLICATION

The present application is based on and claims the benefit of U.S. provisional patent application Ser. No. 63/583,984, filed Sep. 20, 2023, the content of which is hereby incorporated by reference in its entirety.

### BACKGROUND

For many years, municipalities, amusement parks, hotels, and other entities have invested significant resources in the construction of areas dedicated to play-focused entertainment. An increasing number of these areas are now being designed to include a water play area installation such as (but not limited to) a splash pad, a spray park, or an interactive or just-for-watching fountain park. One drawback of a water play area installation is that it requires effort and is often inconvenient to ready and unready the installation between seasons.

### SUMMARY

A water play area installation that includes an underground reservoir tank installed at least partially underground. The water play area installation also includes a water flow regulation hub integrated into the water reservoir tank.

These and various other features and advantages that characterize the claimed embodiments will become apparent upon reading the following detailed description and upon reviewing the associated drawings.

### BRIEF DESCRIPTION OF THE DRAWINGS

FIG. 1 is a schematic diagram of a water play area installation in accordance with one example.

FIG. 2 is a schematic diagram of a water play installation in accordance with one example.

FIG. 3 is a schematic diagram of a touch post activator of a water play installation in accordance with one example.

FIG. 4 is a front elevation view of a control panel of a water play installation in accordance with one example.

FIG. 5 is a perspective view of a water spray element of a water play installation in accordance with one example.

FIG. 6 is a perspective view of a water distribution manifold of a water play installation in accordance with one example.

FIG. 7 is a perspective view of a water reservoir tank of a water play installation in accordance with one example.

FIG. 8 is a perspective view of a water filter system of a water play installation in accordance with one example.

FIG. 9 is a top perspective view of a water treatment system of a water play installation in accordance with one example.

FIG. 10 is a perspective view of a water disinfection system of a water play installation in accordance with one example.

FIG. 11 is a perspective view of an equipment enclosure of a water play installation in accordance with one example.

FIG. 12 is a perspective view of a pre-installed water distribution manifold of a water play installation in accordance with one example.

FIG. 13 is a perspective view of the bottom of a water distribution manifold of a water play installation in accordance with one example.

FIG. 14 is a schematic diagram of an equipment enclosure above a water reservoir tank in accordance with one example.

FIG. 15 is a perspective view of the installation process of a pre-fabricated water play installation in accordance with one example.

FIG. 16 is a perspective view of the installation process of a pre-plumbed water play installation in accordance with one example.

FIG. 17A is a perspective view of the installation process of a water reservoir tank of a water play installation in accordance with one example.

FIG. 17B is a perspective view of the installation process of an equipment enclosure of a water play installation in accordance with one example.

FIG. 17C is a perspective view of a completed installation of an equipment enclosure above a water reservoir tank in accordance with one example.

FIG. 18 is a perspective view of an equipment enclosure having a roof in accordance with one example.

FIG. 19A is a perspective view of a water distribution manifold in accordance with one example.

FIG. 19B is a perspective view of a drainage system of a water distribution manifold in accordance with one example.

FIG. 19C is a perspective view of a drainage system of a water distribution manifold in accordance with one example.

FIG. 20A is a perspective view of the exterior of a water flow regulation hub of a water play installation in accordance with one example.

FIG. 20B is a perspective view of the interior of a water flow regulation hub of a water play installation in accordance with one example.

### DETAILED DESCRIPTION

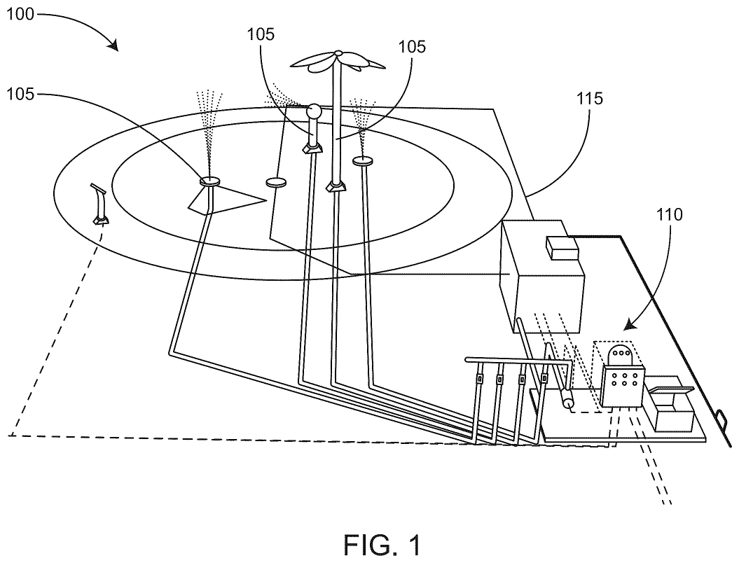

FIG. 1 is a schematic diagram of a water play area installation. Water play area installation 100 includes end user components 105 and operations support components 110. Operations support components 110 are illustratively any suitable component required for a water play area installation and will be described in more detail below. Additionally, water play area installation 100 includes water recycling sub-system 115. Not all water play area installations will include this type of sub-system, but an increasing number of installations do include accommodation for water recycling, so it makes sense to use a system with a water recycling sub-system as an example.

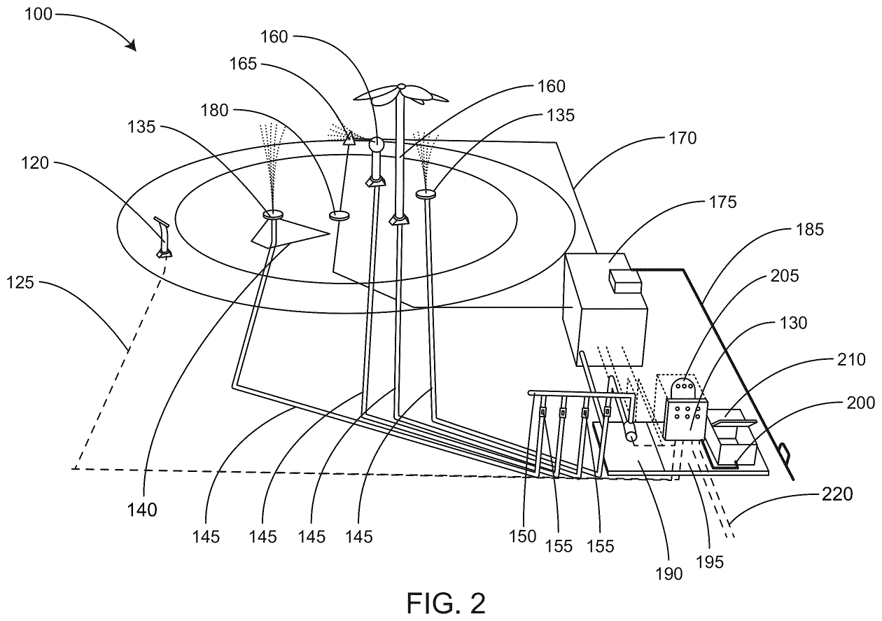

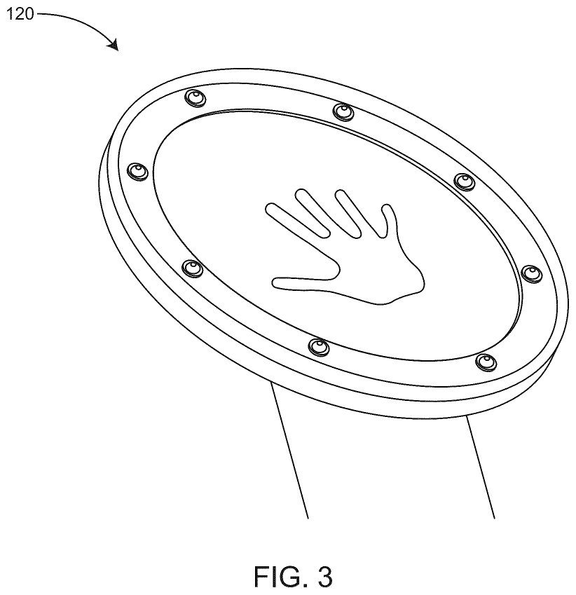

FIG. 2 is a schematic diagram of the same water play area installation 100 as FIG. 1, but in this case, specific elements of the installation have been labeled and will be described in detail below. Water play installation 100 includes touch post activator 120, which can also be referred to more broadly as an activation bollard. In one example, the top portion of touch post activator 120 looks like touch post activator 120 shown in FIG. 3.

Touch post activator 120 shown in FIG. 3 (and more generically shown in FIG. 2) is illustratively a low-voltage proximity sensor located within a bollard cap, the sensor being configured to activate water flow when the cap is pressed. Touch post activator 120 shown in FIG. 3 is illustratively a pre-fabricated and ready to install and go component. Of course, there can be more than one touch post activator 120, any one of which can be configured to turn on/off the entire water play area installation 100, one or more water spray elements, and/or one or more designated zoned areas. Of course, there are many possibilities for specific configurations and the set up will vary from one installation to the next depending upon customer preferences, design considerations, and/or cost considerations, etc.

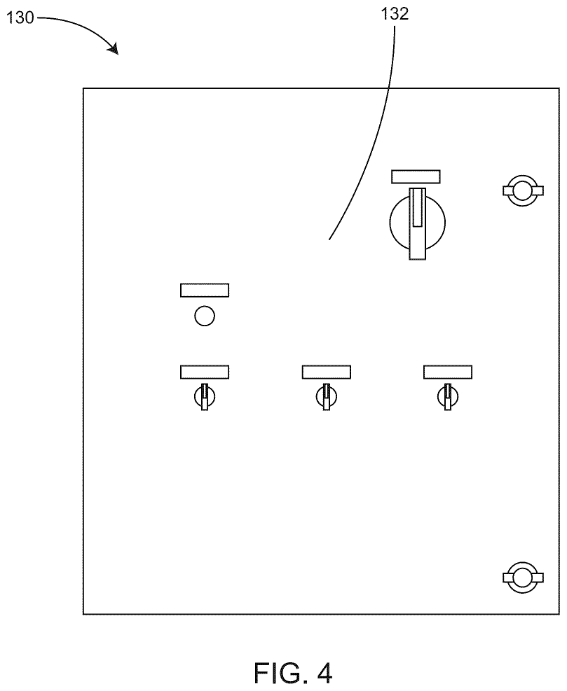

Returning to FIG. 2, electrical/control wiring 125 is utilized to connect touch post activator 120 to system control panel 130. Of course, system control panel 130 can have many configurations depending upon water system requirements and preferences. However, system control panel 130 is, in one example, a pre-fabricated and set up component that is optionally UL Listed and outfitted with any combination of desired total system and/or feature operation controls prior to installation. In one example, supported control options include operational hours, duration of time, sequencing of events, and on/off controls. Additionally, system control panel 130 is configured to support the interactive features enabled by touch post activator(s) 120. In one example, the front portion of system control panel 130 looks like system control panel 132 shown in FIG. 4.

FIG. 4 includes system control panel 130 which is illustratively a pre-fabricated and ready to install and go component. In one example, though not by limitation, system control panel 130 includes command panel 132 having simple on/off water supply controls. However, in another example, command panel 132 is outfitted with a Programmable Logic Controller (PLC) configured to support configuration of water play area zones and/or sequenced water play activities, LED light shows, etc. Additionally, any of these features can illustratively be configured to incorporate interaction with one or more touch post activators (e.g., like touch post activator 120 shown in FIG. 3).

Returning to FIG. 2, FIG. 2 also includes water spray element 135. In one example, water spray element 135 is a ground spray pod, which is illustratively a ground flush spray feature that is configured with any of a variety of different spray nozzles depending upon the preferred spray effect for a given play application. Proximate to water spray element 135 is embedded pod drain 140 which is illustratively a drain feature configured to collect and eliminate standing water in water play area 100. A water play area floor plate may be slightly slanted to direct water to one or more of embedded pod drain 140.

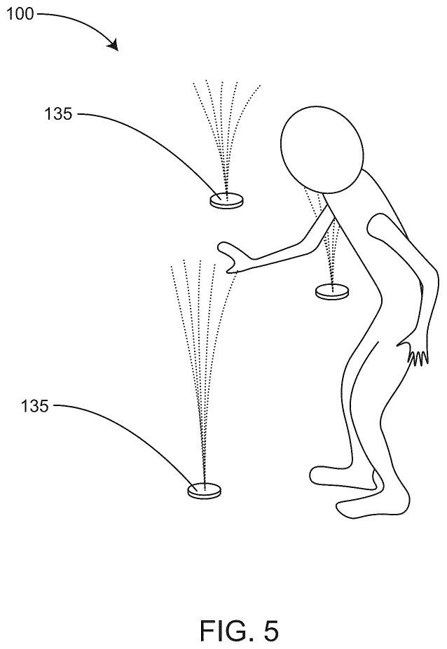

FIG. 5 shows water spray element 135 in action with a user interacting with water spray element 135 within water play area installation 100. Water spray element 135 in water play area installation 100 can come in various forms, offering a wide range of interactive experiences for users. For example, a water play geyser can shoot water upwards in bursts, mimicking natural geysers and encouraging users to stand over the jets or run through the bursts. Similarly, ground pod sprayers spray water in different patterns, creating dynamic water effects that users can hop between. Other examples include water arches that create tunnels of spray for users to run through, misting stations that provide a gentle cooling mist, and water cannons that allow users to control the direction and intensity of the spray. These water features can be equipped with timers to operate at specific intervals and systems to conserve water and may be controlled by touch post activator 120. It is understood that any type of water spray element can be integrated into water play area installation 100 as shown in FIG. 2. Water spray element(s) 135, such as the one depicted in FIG. 5, are for illustrative purposes only and are not intended to be limiting.

As shown in FIG. 2, water supply line(s) 145 connect water distribution manifold 150 to water spray element(s) 135. Water distribution manifold 150 is configured to support water distribution to water supply lines 145 which direct water to water spray elements 135, as well as to other water play features within water play area installation 100. In one example, water distribution manifold 150 is delivered by the manufacturer as a pre-plumbed, pre-fabricated device complete with one or more integrated winterization blow-out-ports. This reduces the burden on any local installation resource, such as a plumber, that might be tasked with doing the intricate work necessary for proper installation. This pre-fabrication also increases the likelihood that installation will be done correctly, as the manufacturer intended.

Of course, water distribution manifold 150 can take on many potential configurations depending upon system requirements and preferences. However, it is generally beneficial for the manifold system to be pre-fabricated and set up for the water play area installation into which it is being integrated. This means providing the appropriate combination of plumbing elements for the installation, etc. As is shown in FIG. 2, in one example, one or more manual control valves 155 are integrated right into water distribution manifold 150. A set of manual control valves 155 provide manual flow control over each water supply line 145 that are connected to a particular spray/water feature in terms of spray height, distance, etc.

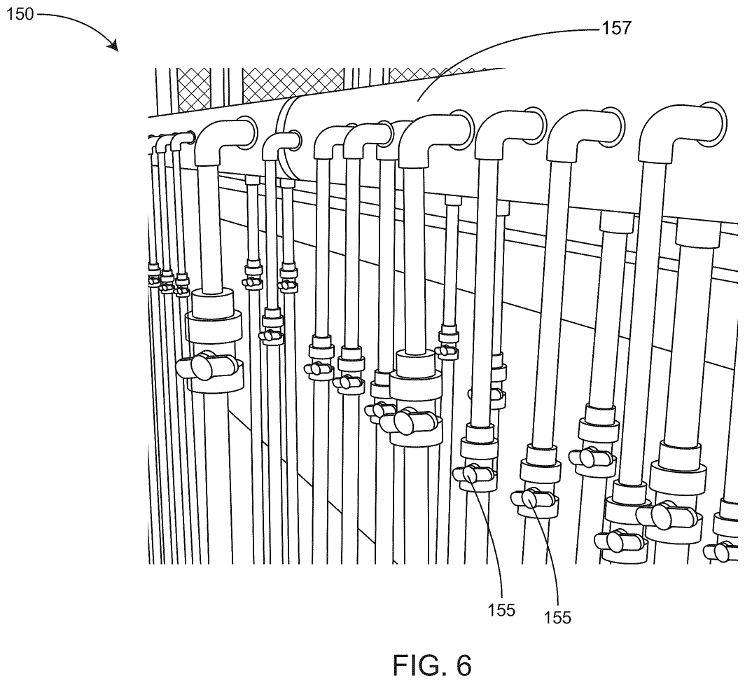

FIG. 6 is a perspective view of a water distribution manifold in accordance with one example. FIG. 6 shows an example of water distribution manifold 150 that is, as has been alluded to, part of a pre-plumbed water delivery system that transfers water from a feature pumping-system (will be described below) to the water features included in the water play area installation. FIG. 6 makes the nature of the manual control valve(s) 155 for regulating water flow more apparent. In one example, one or more of the manual control valves 155 is replaced with an electric valve or solenoid valve, which enables programmatic control for more advanced and even active play element zoning, sequencing, etc. Pipe 157 shown in FIG. 6 coming into the water distribution manifold is illustratively a water supply pipe coming from a water pumping-station in order to supply water to the water distribution manifold 150, and ultimately to each individual water play area element, illustratively including water spray element 135.

Of course, a water play area installation is almost always going to include more than one water play element 135. As a reflection of this, multiple water spray elements 135 are shown in FIG. 2, each element having a dedicated feature water supply line that supports connection to water distribution manifold 150. Further, not all water play elements or water play features need be a ground spray pod like water spray element 135. To reflect this, FIG. 2 is also shown as including water play structure(s) 160. Each water play structure 160 is illustratively an above ground spray feature that supports a water activity or interaction. As shown, each water play structure 160 is also outfitted with a dedicated feature water supply line 145 that supports connection to water distribution manifold 150. Additionally, every water feature (i.e. water spray element 135 and/or water play structure 160) in water play area installation 100 can optionally include a drain to waste feature to support an elimination of standing water in in the element. Those skilled in the art will appreciate that the precise configuration of water play elements in a given water play installation will vary greatly. The precise number and configuration of play elements is not a critical consideration for the purpose of the present description.

It is logical that there also should be a way to remove water from the area in which users are interacting with the water play elements and/or water play features. FIG. 2 also includes water collection port 180, which is illustratively a main drain with a port (in one embodiment a dual port) for collecting water from the play area and returning it through waste line 170 to an underground water reservoir tank 175 (described below in greater detail). FIG. 2 also includes a drain valve box 165 to direct water to waste line 170 after it is collected inside water collection port 180. Waste line 170 is configured to route waste water to a sanitary system, sewer system, recycling system, or equivalent. In one example, waste line 170 may have more than one line to return water back to water reservoir tank 175 or equivalent location. As appreciated by one skilled in the art, waste line 170 is an integrated option for optionally routing different excess water to different end locations, such as water reservoir tank 175 or a municipal sewer drainage. In one example, drain valve box 165 is configured, for example but not by limitation, with an electrical solenoid valve for diverting rain water to particular lines of waste line 170 and into water reservoir tank 175.

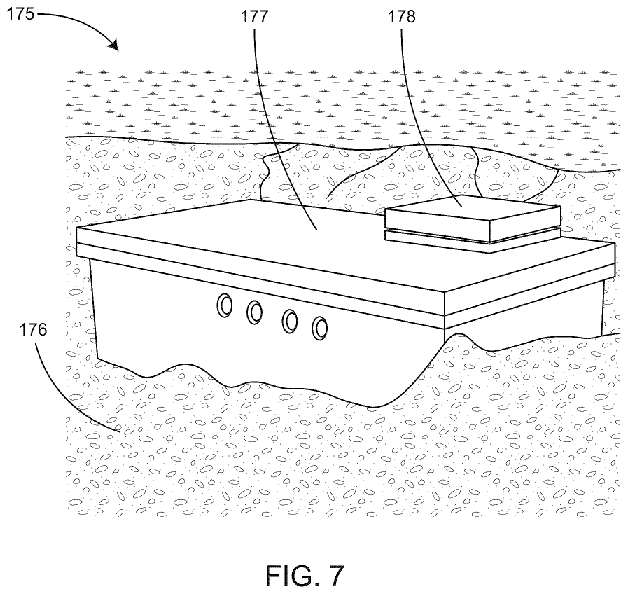

FIG. 7 is a perspective view of a water reservoir tank for a water play area installation in accordance with one example. FIG. 7 includes water reservoir tank 175 prior to it being at least partially covered with soil, concrete, or equivalent filler.

In one example, water reservoir tank 175 is a pre-cast concrete tank (e.g., a 5,000 psi selection meets ASTM C-913 and C-1227)) that is positioned totally or partially under ground level and, in one example, is totally or partially buried within ground 176. As shown, water reservoir tank 175 may include tank lid 177 upon which, in one example, has lockable access hatch 178 mounted along with a service ladder so that a user can access and enter the interior of water reservoir tank 175 when it is empty for season ending/beginning cleaning, etc. In one example, water reservoir tank 175 can be positioned underground such that the top of the walls of the tank are positioned just below ground surface. Tank lid 177 may then be connected to water reservoir tank 175 such that tank lid 177 is substantially flush with the ground surface. In another example, tank lid 177 may be under the ground surface as well. The actual size of the tank itself will vary from one installation to the next depending upon project requirements (e.g., desired flow-rates, size of water play installation, environmental surroundings, etc.).

Returning to FIG. 2, FIG. 2 includes a water fill line connected to the water reservoir tank. Water fill line 185 is essentially a connection to a municipal water supply so that new water can be added as desired to water reservoir tank 175. In one example, water fill line 185 is outfitted with a pressure regulator (e.g., tuned for 20 to 30 PSI) and/or a back-flow preventor (e.g., a one-inch preventer). In one example, water reservoir tank 175 is outfitted (i.e., plumbed) with a water level control mechanism, an inlet loop, a floating skimmer, and/or a submersible pump out system. Different or other components may be included depending on the requirements for a given installation. In one example, water reservoir tank 175 is delivered pre-plumbed with these or any other components not just for convenience and efficiency, but also to maximize the likelihood that all system components will be deployed in an ideal manner.

Those skilled in the art will appreciate that water is ultimately pumped out of water reservoir tank 175 with a water pump system and, in one example, is routed to water distribution manifold 150 and is moved through water distribution manifold 150 to the various water features that are part of water play area installation 100. However, there are a series of operational support components that optionally have an additional processing impact on the water being transported between water reservoir tank 175 and water distribution manifold 150.

The first of these components is water pump skid 190 as shown in FIG. 2. In one example, water pump skid 190 is optionally UL listed, optionally pre-fabricated and optionally pre-plumbed by the manufacturer. In one example, adjustable legs are integrated into water pump skid 190 to enable comfortable ergonomic access to the operational support components. Those skilled in the art will appreciate the nature of the functionality provided by water pump skid 190. Water pump skid may support a variety of operations support components such as a water pumping system, a water purifying system, and/or similar. Facilitation of water transport through a purification system is of key functional importance, of course.

Returning to FIG. 2, the next component that has a process impact before water from water reservoir tank 175 is routed to the water features in water play area installation 100 is filtration skid 195. Filtration skid 195 may support automated chemical controller 200, filter 205, and/or chemical treatment system 210. In one example, these components are optionally UL listed, optionally pre-fabricated and pre-plumbed by the manufacturer. Filter 205 may be a cartridge filter or other style filter provided with media (e.g., sand media). Those skilled in art will appreciate the nature of the intermediate water filtering in conjunction with filter 205. Similarly, those skilled in the art will appreciate the nature of the functions provided by filtration skid 195 and automated chemical controller 200.

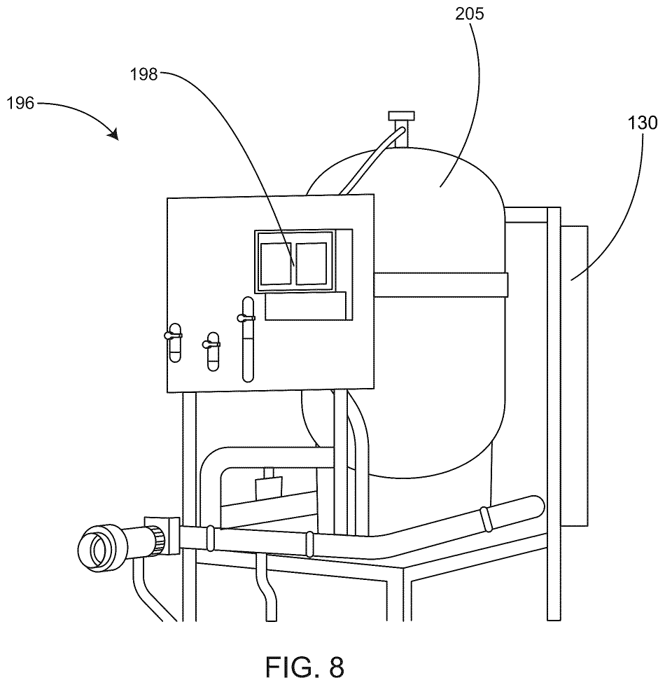

FIG. 8 is an example of a filter (i.e., a sand or cartridge filter) that may be pre-installed on filtration skid 195. Filter system 196 includes filter 205 shown to be positioned behind a control panel (e.g. system control panel 130 as shown in FIG. 4) and includes automated water management display controllers that are illustratively configured to selectively move water from water reservoir tank 175 through the described operations support components as necessary to process the water optimally. In one example, water management (e.g., water chemistry) controller(s) 198 may be positioned in close proximity to the system control panel components that were part of control panel 130, an example of which was shown and described in relation to FIG. 4 and also shown in FIG. 2. In FIG. 8, control panel 130 is shown on one side of filter 205 and the automated water management controller(s) 198 are shown on the opposite side of filter 205. Other configurations are of course possible.

Returning to FIG. 2, the next component that has a process impact before water from water reservoir tank 175 is routed to the water features is chemical treatment system 210. Chemical treatment system 210 may include a water pH adjustment reservoir and associated pump. Those skilled in the art will appreciate the nature of the intermediate water treatment applied in conjunction with chemical treatment system 210.

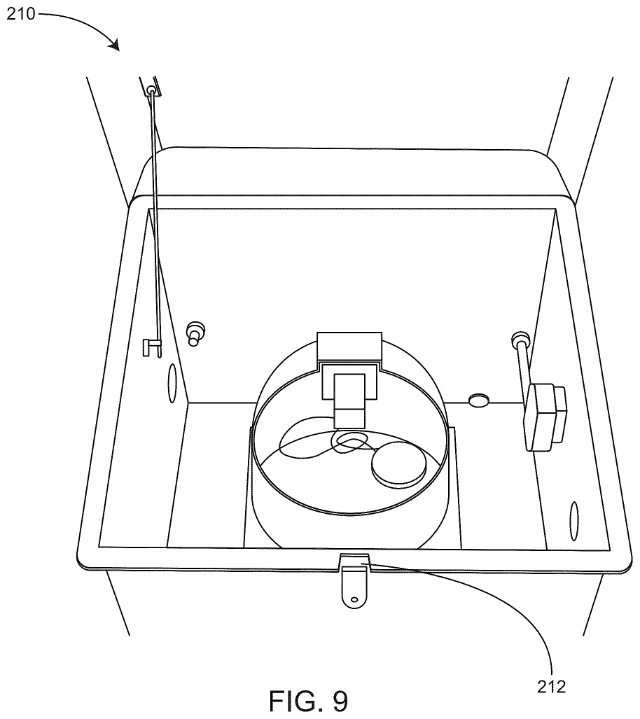

FIG. 9 illustrates an example of a chemical treatment system having a pH adjustment reservoir and associated pump. Chemical treatment system 210 is illustratively deployed with lockable enclosure 212 which can be installed underground or mounted to concrete support pads next to either water pump skid 190 and/or filtration skid 195 shown in FIG. 2. In one example, separate, self-contained chemical enclosures are provided to house chlorine and acid.

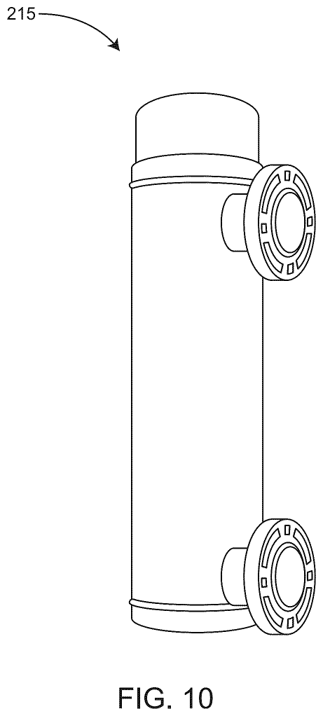

It should be understood that the specific operations support components described herein should not be considered absolutely required for every water play area installation. The precise configuration of components will depend on the requirements for a given installation project. Other components not listed could just as easily be included and optionally come pre-plumbed, pre-fabricated, and/or pre-installed. One example of an additional component is an in-line water heater. Another example is shown in FIG. 10.

FIG. 10 illustrates an ultra-violet disinfection system 215 that is optionally implemented for further water processing. For example, ultra-violet disinfection system 215 provides secondary sanitization within the recirculation system. In some examples, ultra-violet disinfection system 215 is illustratively installed with a water filtration system and/or a water pumping-system. Additionally, ultra-violet disinfection system 215 may be connected to any of the operational support components described herein.

Utilizing pre-plumbed and pre-installed operations support components can save time and labor costs due to quicker installation. As these components can be pre-assembled and tested in controlled environments, components arrive at the installation area ready to go which can ensure high quality and consistency. This also minimizes installation disruption and can enhance safety for both the installers and users of the water play area as this decreases the risk for incorrect assembly.

Some or all of operational support components (i.e. water distribution manifold 150, water supply lines 145, filter 205, chemical treatment system 210, etc.) can be conceptually thought of as optional operations support components. In one example, some or all of these components are concealed within an above or below ground equipment enclosure.

Certain operational support components described herein may require an electrical power supply. Accordingly, in one example as shown in FIG. 2, main power supply 220 is provided. In one example, not by limitation, the main power supply is 460-230V, 3 Phase, 60 Hz and 115/20V, 1 Phase, 60 Hz.

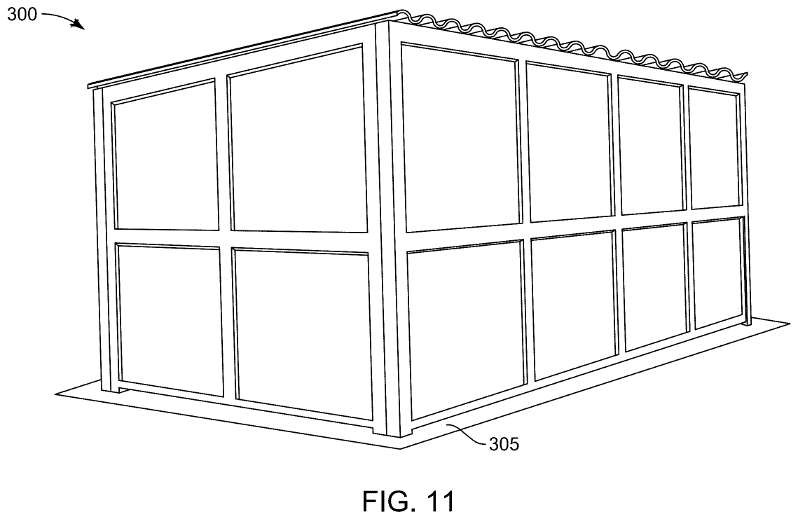

FIG. 11 illustrates an example of an above-ground equipment enclosure. In one example, equipment enclosure 300 is lockable and directly mounted to concrete support pad 305 which is in the general vicinity of a water play area installation. Concrete support pad 305 may be a result of covering water reservoir tank 175 as shown in FIG. 7. In one example, concrete support pad 305 can be configured to be something other than a uniformly flat platform (described in more detail below).

In one example, the manufacturer provides one or more of the operational support components already mounted within equipment enclosure 300, at least partially plumbed and ready for use. This increases installation convenience and increases the likelihood of a proper installation. Thus, in one example, the operations support components may be made available by a commercial provider of water play area installations in either an above-ground skid mounted arrangement, as shown in FIG. 11, or alternatively within an underground vault configuration. In one example, the equipment enclosure can be positioned as an underground vault configuration. In another example, the equipment enclosure may be partially above ground and extend partially below ground according to the specific requirements of the water play installation and the area provided for installation.

The optionally pre-installed operations support components provided within equipment enclosure 300 are configured to provide filtration and chemical treatment of water to ensure healthy water play. In one example, the operations support components are UL Listed and incorporate NSF listed equipment. Of course, recirculation system features will vary depending upon project specific needs and customer desires. In one example, all of the operations support components and also other components such as touch post activator 120, shown in FIG. 2, are provided and delivered by the manufacturer pre-plumbed, pre-wired and therefore in a ready-to-go state for installation.

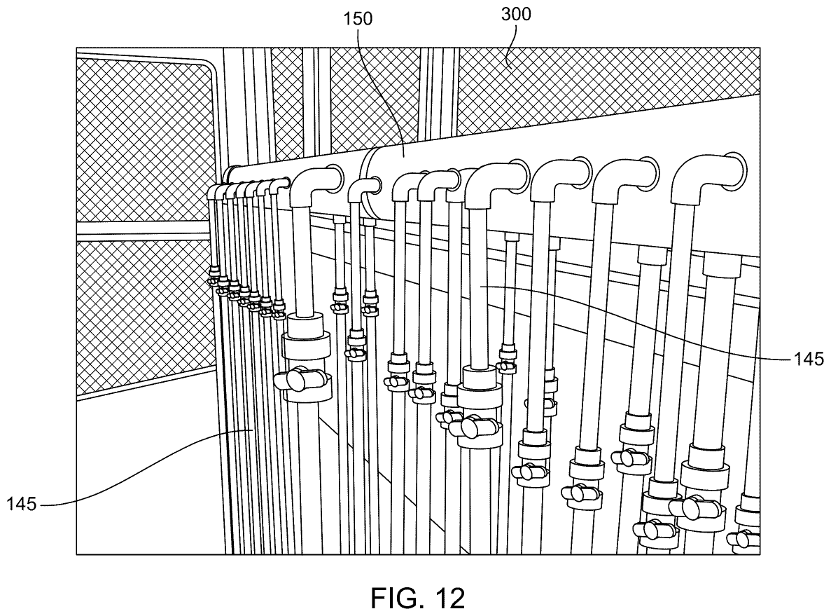

FIG. 12 shows a perspective view of a water distribution manifold that is illustratively consistent with water distribution manifold 150 described above. Water distribution manifold 150 is optionally pre-installed and mounted on an inside wall of equipment enclosure 300 as shown and described in relation to FIG. 11. Water distribution manifold 150 illustratively connects water supply line 145 to one or more play features (e.g., water spray element 135 and/or water play structure 160) that are situated in the play area of water play area installation 100 which is proximate to equipment enclosure 300. In one example, water distribution manifold 150 is delivered to the water play installation area pre-plumbed and already attached to a wall of equipment storage enclosure.

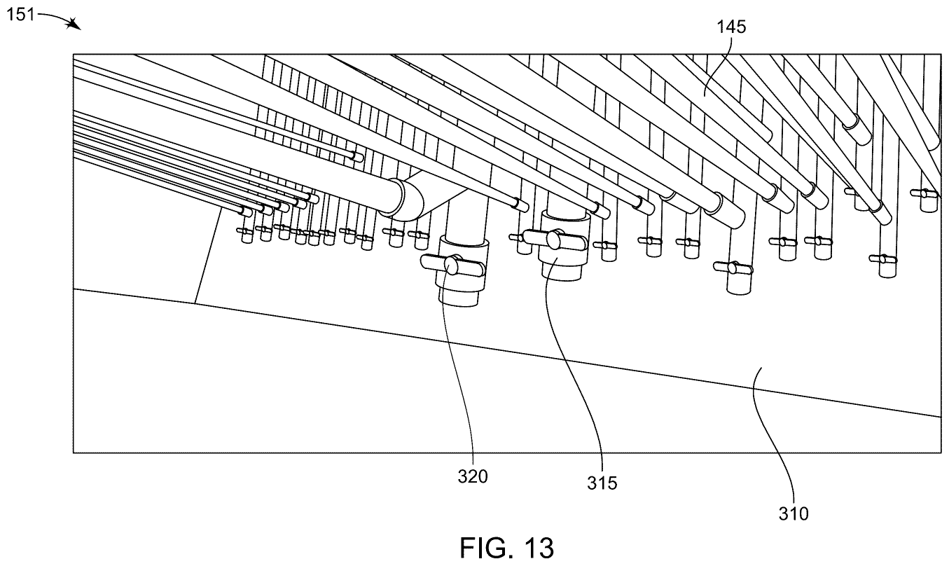

FIG. 13 shows details of a lower portion of the water distribution manifold (illustratively but not necessarily consistent with water distribution manifold 150) which is not visible in FIG. 12. Lower portion 151 of water distribution manifold 150 includes flow control valves 320 which are illustrated in FIG. 13. In particular, the lower portion 151 of water distribution manifold 150 extends into recessed trough 310 that has been formed into concrete support pad 305 as shown in FIG. 11, such that the concrete support pad is no longer uniformly planar or flat and extends below ground level. Recessed trough 310 may be used to drain the water from the water system during the winterization process of the system or any other event where the water pipe network is required to be drained. Therefore, in one example, the water distribution manifold is partially above ground and extends below ground level.

As is also shown in FIG. 13, a series of ball valves 320 (illustratively though not necessarily one ball valve for each water supplied play feature) are provided. In one example, the purpose of the ball valves and the pit is to facilitate a draining of water supply lines 145. For example, a person is able to reach down and open ball valve 320, in the series of ball valves 320, in order to have water in the associated feature water supply line 145 drain into recessed trough 310. Of course, ball valve 320 can then be closed once a drainage process is complete. Ball valve 320 is at the bottom 315 of water supply line 145 in order to utilize the advantage of gravity to facilitate the drainage operation. Because there are many ball valves at the bottom of a trough, they can be relatively cumbersome to service. Additionally, pouring a concrete trough is also slightly more complicated than simply pouring a uniformly flat support pad.

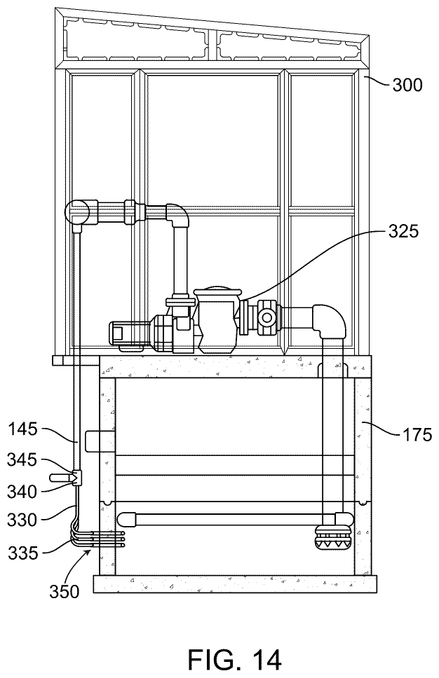

Alternatively, in other examples, alternate arrangements of operation support components of the water play installation area are advantageous especially when they: 1) require less cement/concrete, plumbing and/or other work to be done on-site at the time of installation, and 2) reduce the amount of space required for dedication to mechanical-oriented, non-play components. An example of an alternate arrangement is shown in FIG. 14.

FIG. 14 is a schematic diagram view of a water play area installation arrangement in accordance with one example. This arrangement includes having equipment enclosure 300 (e.g., same or similar to what is shown and described in relation to FIG. 11) being positioned directly above water reservoir tank 175 (e.g., same or similar to the tank shown and described in relation to FIG. 7). An advantage associated with stacking these components is that the required ground surface footprint is less because the ground surface area dedicated to equipment enclosure 300 is more or less the same as the ground surface area dedicated to water reservoir tank 175. Thus, the operational support components associated with a water play area installation can be confined to a smaller space and/or more surface area is available for the water play area components of the installation, such as water spray element(s) 135.

Additionally, equipment enclosure 300 includes pre-installed operations support components 325. Operations support components 325 may include any of the components described above (i.e. chemical treatment system 210, filter 205, etc.) or may include any support components required for a water play installation depending on the size, function, or associated water elements e.g., same or similar to what is shown and described in relation to FIG. 2).

Another advantage associated with stacking the components is that there is now no longer a need to pour a cement/concrete trough (i.e. recessed trough 310) or make some other winterization pit accommodation for draining the water manifold distribution components because water reservoir tank 175 itself can be utilized for this purpose.

Such an arrangement is reflected in FIG. 14 wherein water distribution manifold components 150 are connected to drain insert 330 utilizing drain lines 335. Drain lines 335 are shown extending down from low point 340 of water supply lines 145 at junction location 345. At junction location 345, water supply lines 145 may go in a first direction to direct water to the water play elements, and drain lines 335 may follow a second direction to direct water to hub 350 (shown and described in more detail below).

In one example, drain lines 335 are ½ inch Pex drain lines. In one example, a person standing inside water reservoir tank 175 (e.g., in an empty tank because it is the end of a season or tank is being cleaned) opens drain lines 335 at drain insert 330 proximate to hub 350, causing the water held within the water distribution manifold 150 and water supply lines 145 to drain into water reservoir tank 175 through drain lines 335. In one example, drain insert 330 is configured with a remote-control mechanism that enables drain lines 335 to be drained through remote activation of an open/closed mechanism.

The described stacking of equipment enclosure 300 and water reservoir tank 175 is also advantageous because it opens up an opportunity for most of the water play area installation systems to be pre-fabricated and pre-set up long before being delivered to the installation site. In fact, most of the system can be pre-manufactured and installed prior to delivery. This is advantageous for many reasons, which include, the ability to extensively test the system prior to shipment, simplified installation requirements, reduction of installation time from months to days, reduced installation costs open door to selection of more technically advanced and higher quality mechanical components, and a safter installation work environment.

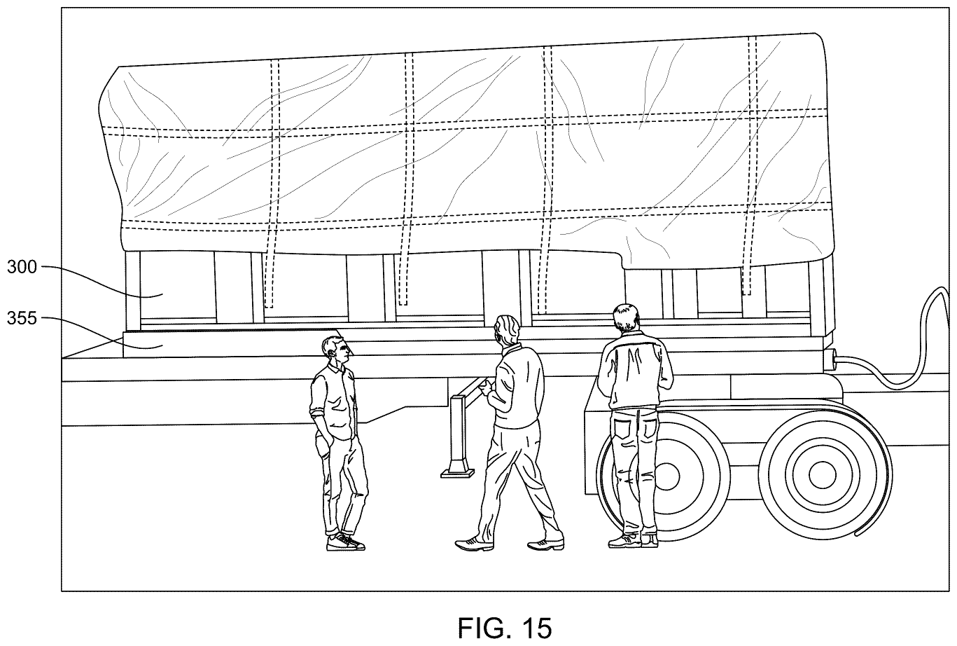

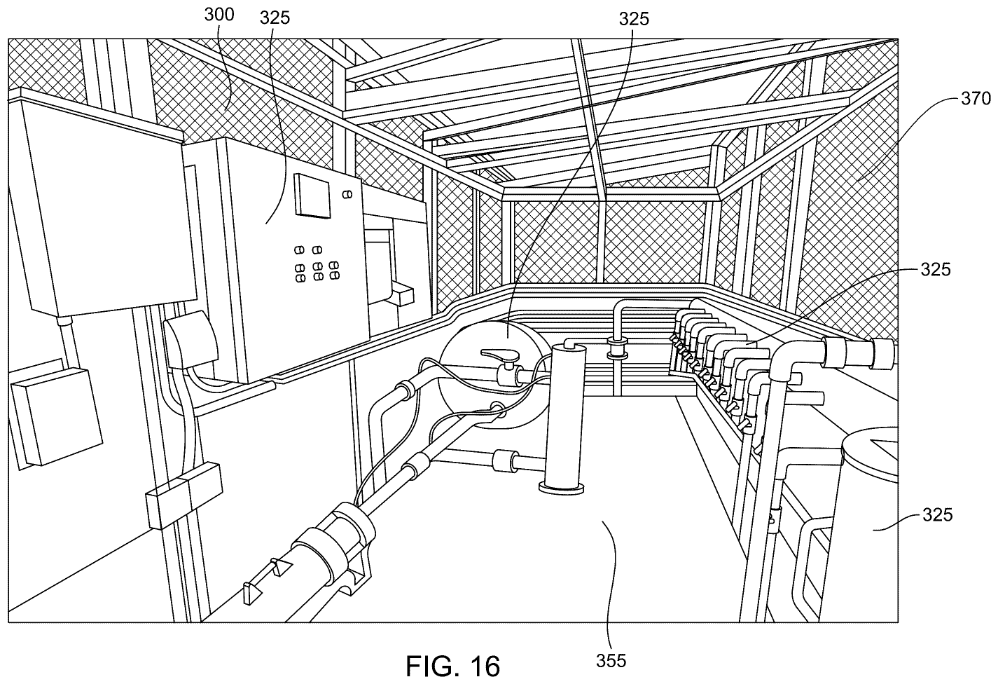

FIGS. 15 and 16 demonstrate just how much of the water play area installation can be pre-fabricated and pre-set up prior to installation at the water play area site. As shown in FIG. 15, equipment enclosure 300 is pre-placed over floor 355 and may eventually become connected to a water reservoir tank (e.g. water reservoir tank 175). Together, the water reservoir tank and the equipment enclosure/lid can even be shipped together on a single truck. Alternatively, the water reservoir tank itself can also be shipped on a single truck. Thus, the two components can be shipped on just two trucks. One skilled in the art will appreciate the arrangement of the components to achieve efficient shipping operations.

FIG. 16 illustratively shows the inside of an equipment enclosure before it has been shipped to the installation site. As shown, most of operations support components 325 of the water play area installation have been pre-installed and pre-mounted to walls 370 and floor 355 of equipment enclosure 300. These components are illustratively pre-plumbed, tested and ready for installation. Operations support components 325 that are inside of equipment enclosure 300 are illustratively the same or similar to those described in relation to FIG. 2 (i.e. water distribution manifold 150, filter 205, chemical treatment system 210, etc.).

In one example, once water reservoir tank 175 and equipment enclosure 300 (including floor 355, which will become connected to the lid of the water reservoir tank) are delivered to the installation site (potentially in a single shipment), they are installed vertically in line with one another.

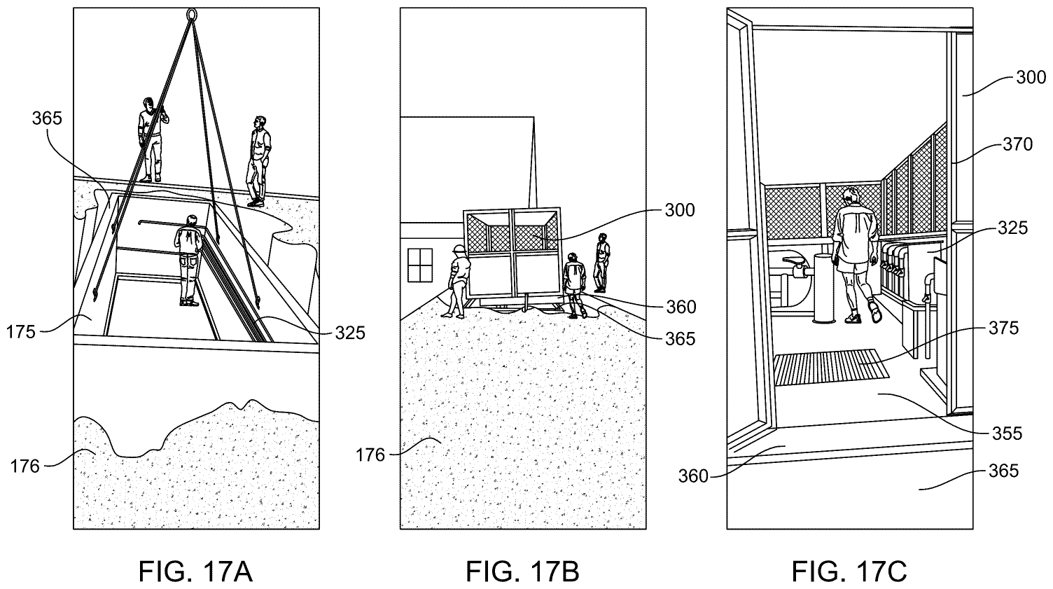

FIGS. 17A-17C illustrate this installation process. FIG. 17A shows how a crane (e.g., but not by limitation a crane capable of lifting 18,000 lbs) has been utilized to lower water reservoir tank 175 into a hole dug into ground 176. Water reservoir tank 175 is illustratively placed, aligned and leveled within the hole. As shown, in one example, water reservoir tank 175 is pre-installed with pre-plumbed operations support components 325 that assist in connecting the components housed within the equipment enclosure to the water play area. Water reservoir tank 175 is illustratively supplied to the installation site in two sections (top section 360 and bottom section 365) in separate part to reduce weight stress on the crane and increase mobility of the lower section 360 during installation.

FIG. 17B shows how the top section/lid is placed onto the bottom section, along with the equipment enclosure and its associated pre-installed, pre-plumbed components. In one example, top section 360 of the tank is installed utilizing a stick joint sealant between the two tank sections. As shown, the top section 360 of the tank acts as a floor for equipment enclosure 300. Thus, equipment enclosure 300 and top section 360 are illustratively affixed on top of bottom section 365 of water reservoir tank 175 utilizing joint sealant. In one example, top section 360 is constructed with floor 355 of equipment enclosure 300. Thus, top section 360 may be delivered as a part of equipment enclosure 300. In another example, equipment enclosure 300, top section 360, and bottom section 365 will be assembled at the water play area.

FIG. 17C provides an example of the circumstances after the two water reservoir tank sections have been aligned and connected with one another. Equipment enclosure 300 includes walls 370, floor 355 and tank access lid 375. In one example, tank access lid 375 is integrated into floor 355 before alignment of equipment enclosure 300 over bottom section 365 of water reservoir tank 175. In this example, equipment enclosure 300 may have a perimeter formed by walls 370, and tank access lid 375 is positioned within the perimeter of walls 370 to provide access to the interior cavity of water tank reservoir 175. As appreciated by one skilled in the art, this eliminates the need for an additional tank access point at some other location in the water play area.

In one example, tank access lid 375 includes a lockable opening. Additionally, as shown, operation support components 325 are pre-installed to walls 370 and floor 355 of equipment enclosure 300 prior to the connection of equipment enclosure 300 to bottom section 360 of water reservoir tank 175.

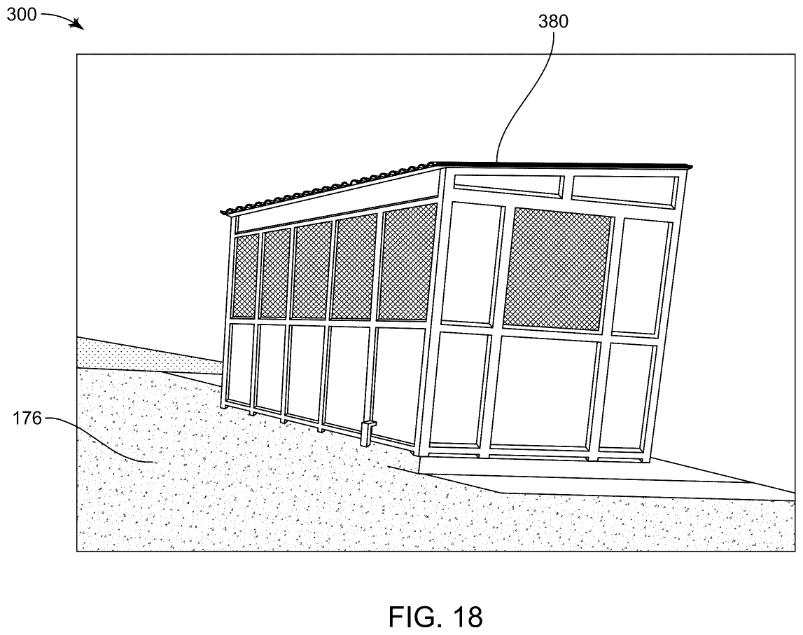

Ultimately, a roof is installed on top of the equipment enclosure. FIG. 18 shows roof 380 being installed on equipment enclosure 300. Also as shown in FIG. 18, ground 176 has also been filled in again around water reservoir tank 175. Of course, completion of the plumbing between components inside and outside of the equipment enclosure is done before the hole is ultimately filled in. Such plumbing includes connecting the operations support components, such as connecting water distribution manifold 150 to water reservoir tank 175 for water supply line drainage purposes, as discussed above.

Additionally, one of the plumbing tasks that is still necessary to complete at the water play area installation is the connection of the water distribution manifold to the various water play features. As shown in FIG. 16, in one example, an upper portion of water distribution manifold 150 is attached to wall 370 of equipment enclosure 300 and must be connected to the water play elements and/or the water reservoir tank 175.

However, lower portions of water distribution manifold 150 illustratively extend down below the ground surface, as shown in FIG. 14. This is possible when, in one configuration, equipment enclosure 300, which houses water distribution manifold 150, is off set instead of being directly over the top section 365 (i.e. floor 355) of water reservoir tank 175. Thus, in some examples, walls 370 of equipment enclosure 300 are not directly aligned with top section 365 of water reservoir tank 175. In another example, the perimeter formed by walls 370 of equipment enclosure 300 may be greater than a perimeter formed by the water reservoir tank 175.

Therefore, portions of water supply lines 145 extending from water distribution manifold 150 which feed water to the play elements can drop below the ground surface in a manner similar to how they dropped into a recessed trough, as was described in relation to FIGS. 12 and 13. By having the portions of water supply lines 145 extend below the ground surface, this allows water supply lines 145 to run vertically alongside a wall of lower portion 360 of water reservoir tank 175. As it is becoming apparent, placement of water distribution manifold 150 in close proximity to water reservoir tank 175 opens up an opportunity to eliminate the need for a recessed trough.

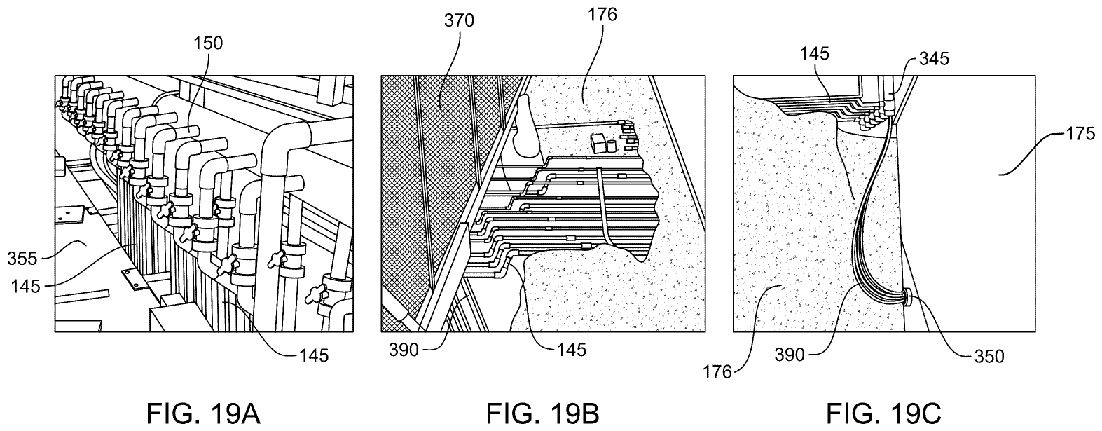

FIGS. 19A-19C demonstrate an arrangement for draining the water lines of the water distribution manifold. FIG. 19A includes water supply lines 145 (e.g., that feed out to play elements in the water play area) of water distribution manifold 150 extending down below floor 355 and walls 370 of equipment enclosure 300.

As shown in FIG. 19B, water supply lines 145 are connected (illustratively though not necessarily at a right angle) to a series of additional water supply lines 145 that each feed out to the play elements in the water play area, such as water spray element(s) 135. This example illustrates water supply lines extending outside of walls 370 of equipment enclosure 300, and beneath ground 176. Additionally, FIG. 19B partially shows a portion of water supply lines 145 being connected to water drainage lines 390 and additional water supply lines 145 at junction location 345, which is more visible in FIG. 19C.

FIG. 19C is a lower view showing the same components as in FIG. 18 and shows the bottom side of water supply lines 145 that each run out to the water play elements. Water drainage lines 390 (e.g., ½ inch Pex tubing) are shown extending down from a low point of water supply lines 145 at junction location 345. At junction location 345, the water is directed in a first direction and a second direction. Following the first direction, water supply lines 145 are routed substantially parallel with ground level to direct water to the water play elements in the water play area.

Following the second direction, water drainage lines 390 run substantially perpendicular to ground level, and substantially parallel with water reservoir tank 175, to direct water to hub 350. It is understood that junction location 345 may include more or less directions to route water to more or less locations. Additionally, junction location 345 illustratively includes an actuating mechanism to allow a user to change the direction of the water. In one example, the actuating mechanism is a manual valve or a remote-controlled valve.

Water drainage lines 390 each illustratively connect each one of water supply lines 145 to hub 350 that is integrated into water reservoir tank 175. In one example, hub 350 is a winterization hub that allows drainage of water into the interior of water reservoir tank 175 during an end of season drainage process. Thus, this eliminates the need to have ball valves that, when activated, drain into an additional winterization pit and/or recessed trough. Instead, when water drainage lines 390 and hub 350 are opened, they are illustratively configured to drain into water reservoir tank 175. Hub 350 is illustratively configured to regulate water flow into the water reservoir tank 175.

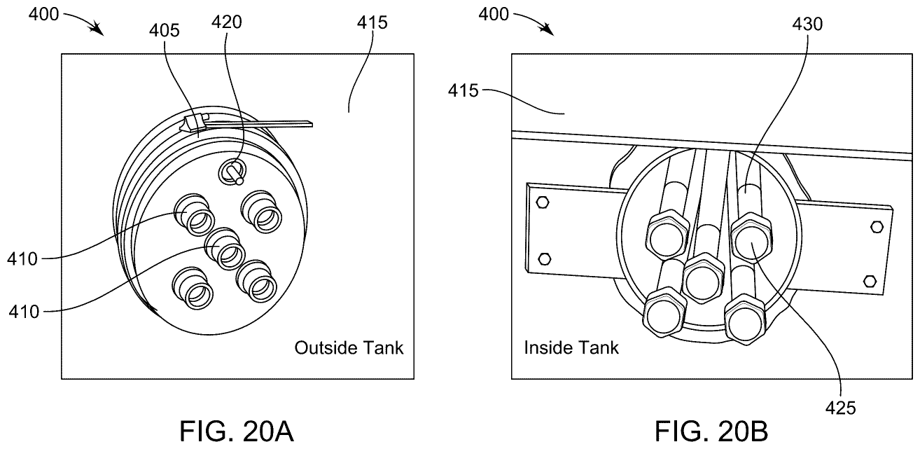

FIGS. 20A and 20B show an example of what a hub looks like. FIG. 20A is a perspective view of a first side of water regulation hub 400 from the outside of the water reservoir tank. As shown and described, water regulation hub 400 is one variation of hub 350. It is understood that there may be other configurations of hub 350 to achieve the same or similar purpose of regulating water flow to a reservoir location. In one example, water regulation hub 400 may be used in a winterization process of the water play installation. FIG. 20B is a perspective view of a second side of water regulation hub 400 from the inside of the water reservoir tank. One or both sides of water regulation hub 400 shown in FIGS. 20A and 20B are illustratively though not necessarily comprised of stainless-steel material.

In one example, more than one of water regulation hub 400 will be included, depending upon how many tubing runs need to be supported for the drainage of water supply lines 145. Water regulation hub 400, shown in FIG. 20A, includes body 405 which has ports 410 that are configured to receive water drainage lines 390, as shown and described in FIGS. 19B-19C. Body 405 extends through wall 415 of water reservoir tank 175. As such, when ports 410 are opened through use of actuator 420, water can drain into the interior of water reservoir tank 175.

In one example, as shown in FIG. 20B, water regulation hub 400 may include caps 425 positioned on water lines 430. Water lines 430 are connected and/or integrated to ports 410. Caps 425 are connected to water lines 430 on the inside of water reservoir tank 175 and are removable. Caps 425 may be threaded caps and are unthreaded for temporary removal to allow a drainage process into water reservoir tank 175. Removing caps 425 will illustratively cause water to run out of water lines 430 and into the interior of water reservoir tank 175. Caps 425 function as a preventive measure to prevent the backflow of water into water lines 430 once the drainage process is complete.

In another example, instead of caps 425, another mechanism may be substituted, such as one or more valves. In one example, the valve(s) are mechanically or electronically actuated between an open and closed position. In one example, a remote-control interface is included that supports remotely opening and closing for water line drainage. In an alternative example, water lines 430 may be manufactured with a backflow prevention actuator to prevent backflow altogether.

Although the present invention has been described with reference to preferred embodiments, workers skilled in the art will recognize that changes may be made in form and detail without departing from the spirit and scope of the invention.

What is claimed is:

1. A water play area installation, comprising:
an underground water reservoir tank installed at least partially underground; and
a water flow regulation hub integrated into the water reservoir tank.

2. The water play area installation of claim 1, further comprising an equipment enclosure positioned directly above the underground water reservoir tank.

3. The water play area installation of claim 1, further comprising at least one water supply line.

4. The water play installation of claim 3, wherein the at least one water supply line further comprises a junction location to direct water in a first and second direction.

5. The water play installation of claim 4, wherein the first direction directs water to a water spray element in a water play area.

6. The water play installation of claim 4, wherein the second direction directs water to the water flow regulation hub.

7. The water play installation of claim 4, wherein the junction location comprises an actuator to regulate water flow in the first and second directions.

8. The water play area installation of claim 1, wherein the water regulation hub comprises at least one passage that extends from the exterior of the underground water reservoir tank to the interior of the underground water reservoir tank.

9. The water play area installation of claim 8, wherein the passage has a first end and a second end, the first end being configured to receive a water line.

10. The water play area installation of claim 9, wherein the second end comprises a cap configured to regulate water flow.

11. A water play area winterization system, comprising:
an underground water reservoir tank having an integrated water flow regulation hub; and
at least one water supply line with a junction location leading to a first line and a second line, the first line directing water to at least one water play element and the second line directing water to the integrated water flow regulation hub.

12. The water play area winterization system of claim 11, wherein the water flow regulation hub extends through a wall of the underground water reservoir tank to allow water into an interior cavity of the water reservoir tank.

13. The water play area winterization system of claim 11, wherein the integrated water flow regulation hub comprises at least one port configured to receive the second line.

14. The water play area winterization system of claim 13, wherein the at least one port further comprises an actuator configured to regulate water flow.

15. The water play area winterization system of claim 14, wherein the actuator is remotely controllable.

16. A water flow regulation hub integrated into a water reservoir tank of a water play area installation, the water flow regulation hub comprising:
a body extending through a wall of the water reservoir tank;
at least one drain line having a first end and a second end mounted within the body, the first end configured to receive at least one water supply line; and
at least one actuator connected to the second end of the at least one drain line.

17. The water flow regulation hub of claim 16, wherein the body is comprised at least partially of stainless steel.

18. The water flow regulation hub of claim 16, wherein the water flow regulation hub is mounted to the wall of the water reservoir tank.

19. The water flow regulation hub of claim 16, wherein the at least one actuator comprises a threaded cap.

20. The water flow regulation hub of claim 16, wherein the at least one actuator comprises a valve having an open and closed position.
